(19) United States
(12) Patent Application Publication
(10) Pub. No.: US 2009/0252405 A1
(43) Pub. Date: Oct. 8, 2009

(54) METHOD AND APPARATUS FOR DICTIONARY-BASED IMAGE PROCESSING

(76) Inventor: Sangkeun Lee, Seoul (KR)

Correspondence Address: Myers Andras Sherman LLP, 19900 MacArthur Blvd., Suite 1150, Irvine, CA, 92612, US

(21) Appl. No.: 12/062,467

(22) Filed: Apr. 3, 2008

(51) Int. Cl. G06K 9/62

(52) U.S. Cl. 382/159

(57) ABSTRACT

A method and system for processing a digitized image including multiple pixels is provided. Image processing involves determining a characteristic value for a set of image pixels, determining a classification for the set of pixels based on the characteristic value, accessing a dictionary including transforms, and retrieving transforms for the set of pixels based on said classification, and applying the transforms to the set of pixels to obtain output pixels.

### FIELD OF THE INVENTION

The present invention relates in general to image processing, and in particular to image/video enhancement or restoration.

### BACKGROUND OF THE INVENTION

With the proliferation of digital media, the number of digital image/video systems is on the rise. In such systems, digital information is transferred between various components. However, digitized image/video data can be degraded when transferred.

As such, image restoration and enhancement techniques are applied in various image processing systems/platforms to restore or enhance degraded image/video data. Many image data restoration and enhancement approaches may be utilized. However, such approaches often require different systems/platforms. This results in high overall hardware size and cost as the different approaches cannot efficiently share similar image processing platforms/systems.

### BRIEF SUMMARY OF THE INVENTION

The present invention provides a method and system for processing a digitized image including multiple pixels. One embodiment involves determining a characteristic value for a set of image pixels, determining a classification for the set of pixels based on the characteristic value, accessing a dictionary including transforms, and retrieving transforms for the set of pixels based on said classification, and applying the transforms to the set of pixels to obtain output pixels.

The transforms may include weighting coefficients. Further, determining a characteristic value for the set of pixels may further include reordering the set of pixels based on a selected image processing type, and determining a characteristic value for the set of reordered pixels. Accessing a dictionary may further include accessing a dictionary including weighting coefficients for said image processing type, and retrieving weighting coefficients therefrom for the set of pixels based on said classification. Applying the weighting coefficients to the reordered set of pixels may further include applying the weighting coefficients to the set of pixels according to said selected image processing type to obtain weighted pixel values, and combining the weighted pixel values to generate output image pixels.

These and other features, aspects and advantages of the present invention will become understood with reference to the following description, appended claims and accompanying figures.

### BRIEF DESCRIPTION OF THE DRAWINGS

FIG. 1 shows a functional block diagram of a system implementation of a dictionary-based processing platform, according to an embodiment of the present invention.

FIG. 2 shows a flowchart of the steps of dictionary-based image processing, according to an embodiment of the present invention.

FIG. 3 shows a flow diagram for application of a dictionary-based processing platform to image pixel processing, according to an embodiment of the present invention.

### DETAILED DESCRIPTION OF THE INVENTION

The present invention provides a method and system for a dictionary-based processing platform which may be utilized as a common platform for image/video enhancement and restoration, according to trained dictionary data.

In one embodiment, the dictionary-based processing platform provides a common procedure for image/video enhancement and restoration of image/video data under specific circumstance based on a dictionary implemented as a LookUp Table (LUT).

The size of the LUT is actively reduced. For a digitized image represented by a two-dimensional frame of pixels, a pixel reordering technique is implemented to reduce the size of the LUT.

As a result, the dictionary-based processing platform requires reduced overall hardware size for an image processing system by providing a common platform that may be shared with different image processing techniques, each such technique utilizing its own LUT in a dictionary (or a separate dictionary may be used per technique).

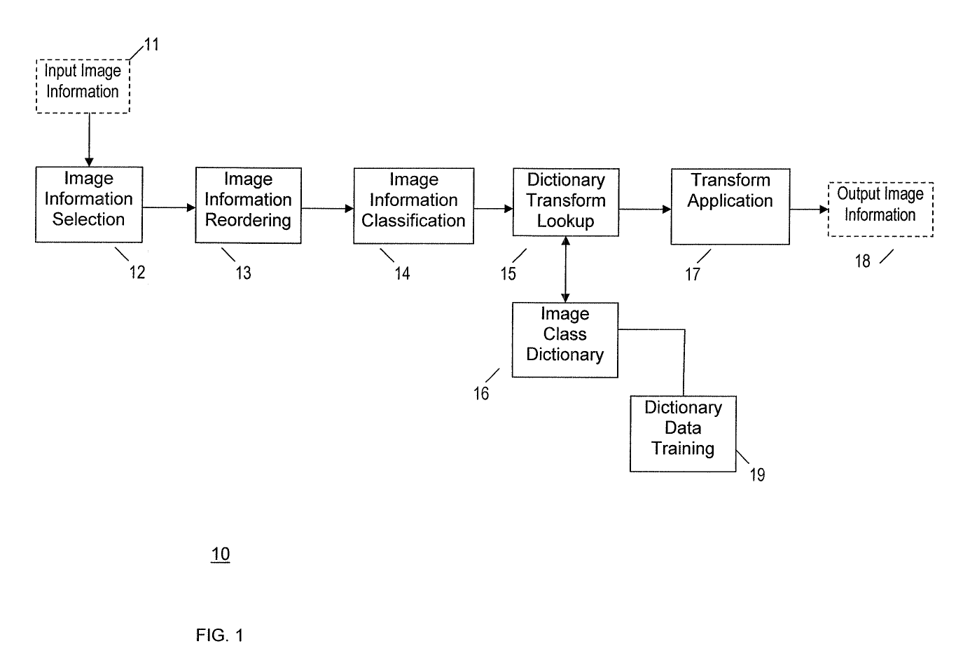

FIG. 1 shows a functional block diagram of a system implementation of a dictionary-based processing platform 10, according to an embodiment of the present invention. The platform 10 comprises an image information selection module 12 which selects pixel information from the image information 11, an image information reordering module 13, an image information classification module 14, a dictionary transform lookup module 15 for looking up transform information for the image class in a class dictionary 16, and a transform application module 17 for application of the transform to the input image information 11 to generate output image information 18. A dictionary data training module 19 provides the dictionary data for various image processing algorithms.

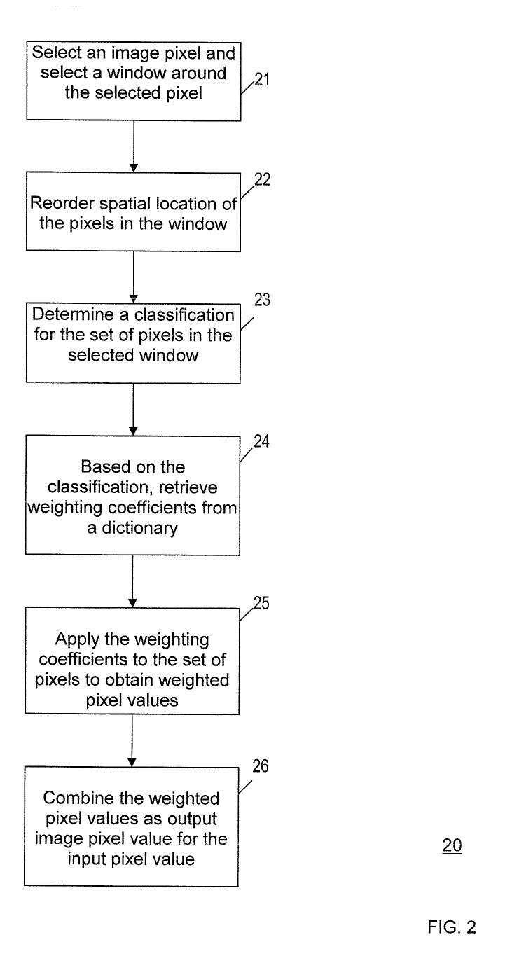

FIG. 2 shows a flowchart of the steps of a dictionary-based image process 20 implemented by the platform 10, according to an embodiment of the present invention. The process 20, applied to an array (frame) of pixels representing a digitized image, includes the following steps
Step 21: Select an input image pixel, select a window of a certain size on the pixel, and select the pixels in the window. In one example, a window of size 5×5 can be used. Other window sizes are also possible.
Step 22: Reorder the spatial location of the pixels in the window based on a predefined definition (such as sorting of the distance form the center) based on the image processing desired. The advantage of the reordering is to obtain unique information regardless of the geometric formation of the pixels. For an example, when a window containing pixel values in an image is geometrically rotated, the locations of the pixels are changed. However, the reordering pixel values will remain regardless of geometric changes.
Step 23: Generate a measure for the characteristics of one or more pixels in the set of pixels in the window and determine a classification for the set of pixels based on said measure. The measure λ is determined by the geometrical distance between pixel locations P(q), where q=[m n]^{T} and a center pixel P(p), in a window W as:

$$λ = \frac{1}{{D}_{Total}} {\sum }_{P ∈ W} \frac{1}{D ( P ( q ) - P ( p ) )} \vert W ( P ( q ) ) - W ( P ( p ) ) \vert for q \neq p .$$

P is the predefined pixel location in the window and a total distance from the center to neighbors D_{Total} is defined by:

$${D}_{Total} = {\sum }_{P ∈ W} D ( P ( q ) - P ( p ) ) , and$$

$$D ( P ( q ) - P ( p ) ) = \vert P ( q ) - P ( p ) \vert .$$

Where P( ) are vectors indicating pixel location in a window.
Step 24: Based on the classification, retrieve a transform including weighting coefficients from a dictionary. The weighting coefficients indicate the elements consisting of a class. The dictionary can be an off-line trained lookup table, for the class of the current pixel values.
Step 25: Apply the weighting coefficients to the set of pixels. Specifically perform one-to-one multiplication on the reordered pixel values with the weighting coefficients.
Step 26: Combine (e.g., add) the weighted pixel values as output image pixel value for the input pixel value.

The above steps 21-26 may be repeated for each pixel in an image frame by using shifting a window for each pixel.

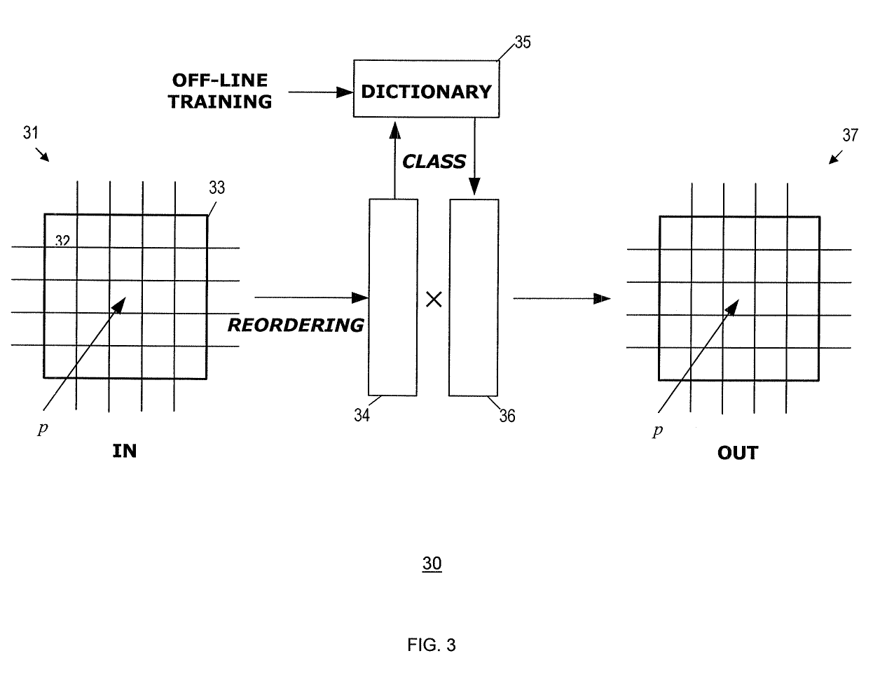

FIG. 3 shows a flow diagram 30 for application of a dictionary-based process 20 to an image pixel processing, according to an embodiment of the present invention. An input image frame 31 including multiple pixels 32 is processed by selecting a pixel p and selecting a window 33 around the pixel p. The selected pixel p is shown at the center of the window 33.

For each selected pixel p, the pixel p and its neighboring pixels in the window 33 are reordered into a set 34 according to their spatial distances and intensity deviations, relative to the pixel p according to a penalty function. The penalty function works inverse proportional to the distance between the pixel p and the center pixel of a window. A classification is determined for the pixels to lookup weighting coefficients 36 from a dictionary 35. The classification is obtained by quantizing the measure A based on the predefined table. The weighting coefficients are multiplied to the reordered pixels 34 to obtain an output image 37.

Several approaches for training data and implementing a dictionary efficiently are possible. An example based on a least mean square (LMS) optimization is provided below.

An example is described below for processing a distorted image 31 to be restored/enhanced. Each pixel p and its neighboring pixels in the window 33, belonging to a specific class and their corresponding pixels in the reference images are accumulated to compute weighting coefficients in a dictionary 35.

Let f_{c}^{I}(p) and f_{c}^{R}(p) represent the windows in a distorted input image and a reference image for a particular class c, respectively. The reference image comprises the undistorted image. Then, an output value f_{c}^{O}(p) for the pixel p located at p=[m n]^{T} in the input image can be expressed as relation (1) below:

$${f}_{c}^{O} ( p ) = {\sum }_{i = 0}^{n - 1} {w}_{c} ( i ) {f}_{c}^{I} ( i , p ) , \qquad ( 1 )$$

wherein f_{c}^{I}(i, p) is an element of the given window with a class c, centered at pixel p, and w_{c}(i) is a set of weighting coefficients. The order i of elements in the window centered at pixel location p is determined by a reordering process for each image processing application.

An error e_{c} at the pixel location p belonging to a class c in an image can be expressed as relation (2) below:

e_{c}(p)=f_{c}^{R}(p)−f_{c}^{O}(p). (2)

If the number of pixel locations belonging to the class c is NC, then the error in the class c is

$${\sum }_{p ∈ c}^{{N}_{c}} {e}_{c} ( p ) .$$

Therefore, a total error for class c in the image window can be expressed as relation (3) below:

$${e}_{c} = {\sum }_{p ∈ c}^{{N}_{c}} {e}_{c} ( p ) = {\sum }_{p ∈ c}^{{N}_{c}} ( {f}_{c}^{R} ( p ) - {f}_{c}^{O} ( p ) ) . \qquad ( 3 )$$

Then, the squared error is expressed as relation (4) below:

$${e}_{c}^{2} = {\sum }_{p ∈ c}^{{N}_{c}} {( {f}_{c}^{R} ( p ) - {f}_{c}^{O} ( p ) )}^{2} = {\sum }_{p ∈ c}^{{N}_{c}} {( {f}_{c}^{R} ( p ) - {\sum }_{i = 0}^{n - 1} {w}_{c} ( i ) {f}_{c}^{I} ( i , p ) )}^{2} . \qquad ( 4 )$$

To minimize the squared error e_{c}², the first derivative of e_{c}² to each element w_{c}(k), for kε[0, . . . , n−1] should be equal to zero as relation (5) below:

$$\frac{\partial {e}_{c}^{2}}{\partial {w}_{c} ( k )} = {\sum }_{p ∈ c}^{{N}_{c}} 2 {f}_{c}^{I} ( k , p ) ( {f}_{c}^{R} ( p ) - {{\sum }_{i = 0}}^{n - 1} {w}_{c} ( i ) {f}_{c}^{I} ( i , p ) ) = 0. \qquad ( 5 )$$

Rearranging terms of relation (5) above provides relation (6) below:

$${\sum }_{p ∈ c} {f}_{c}^{I} ( k , p ) {f}_{c}^{R} ( p ) = {\sum }_{p ∈ c} {f}_{c}^{I} ( k , p ) {\sum }_{i = 0}^{n - 1} {w}_{c} ( i ) {f}_{c}^{I} ( i , p ) . \qquad ( 6 )$$

Rearranging terms of relation (6) above provides relation (7) below:

$${{\sum }_{p = 0}}^{{N}_{c} - 1} {f}_{c}^{I} ( k , p ) {f}_{c}^{R} ( p ) = {\sum }_{i = 0}^{n - 1} {w}_{c} ( i ) {\sum }_{p = 0}^{Nc - 1} {f}_{c}^{I} ( k , p ) {f}_{c}^{I} ( i , p ) . \qquad ( 7 )$$

Relation (7) above can be expressed in a closed matrix form, starting with k=0, as relation (8) below:

$$\begin{matrix}{\sum }_{p = 0}^{{N}_{c} - 1} {f}_{c}^{I} ( 0 , p ) {f}_{c}^{R} ( p ) = {\sum }_{i = 0}^{n - 1} {w}_{c} ( i ) {\sum }_{p = 0}^{Nc - 1} {f}_{c}^{I} ( 0 , p ) {f}_{c}^{I} ( i , p ) \\ = [ {\sum }_{p = 0}^{{N}_{c} - 1} {f}_{c}^{I} ( 0 , p ) {f}_{c}^{I} ( 0 , p ) … \\ {\sum }_{p = 0}^{{N}_{c} - 1} {f}_{c}^{I} ( 0 , p ) {f}_{c}^{I} ( n - 1 , p ) ] \\ [ \begin{matrix}{w}_{c} ( 0 ) \\ ⋮ \\ {w}_{c} ( n - 1 )\end{matrix} ] .\end{matrix} \qquad ( 8 )$$

When k=n−1, the matrix can be expressed as relation (9) below:

$$\begin{matrix}{\sum }_{p = 0}^{{N}_{c} - 1} {f}_{c}^{I} ( n - 1 , p ) {f}_{c}^{R} ( p ) = {\sum }_{i = 0}^{n - 1} {w}_{c} ( i ) {\sum }_{p = 0}^{Nc - 1} {f}_{c}^{I} ( n - 1 , p ) {f}_{c}^{I} ( i , p ) \\ = [ {\sum }_{p = 0}^{{N}_{c} - 1} {f}_{c}^{I} ( n - 1 , p ) {f}_{c}^{I} ( 0 , p ) … \\ {\sum }_{p = 0}^{{N}_{c} - 1} {f}_{c}^{I} ( n - 1 , p ) {f}_{c}^{I} ( n - 1 , p ) ] \\ [ \begin{matrix}{w}_{c} ( 0 ) \\ ⋮ \\ {w}_{c} ( n - 1 )\end{matrix} ] .\end{matrix} \qquad ( 9 )$$

Therefore providing relation (10) below:

$$[ \begin{matrix}{\sum }_{p = 0}^{{N}_{c} - 1} {f}_{c}^{I} ( 0 , p ) {f}_{c}^{R} ( p ) \\ ⋮ \\ {\sum }_{p = 0}^{{N}_{c} - 1} {f}_{c}^{I} ( n - 1 , p ) {f}_{c}^{R} ( p )\end{matrix} ] = \begin{matrix}[ \begin{matrix}{\sum }_{p = 0}^{{N}_{c} - 1} {f}_{c}^{I} ( 0 , p ) {f}_{c}^{I} ( 0 , p ) & ⋯ & {\sum }_{p = 0}^{{N}_{c} - 1} {f}_{c}^{I} ( 0 , p ) {f}_{c}^{I} ( n - 1 , p ) \\ & ⋮ & \\ {\sum }_{p = 0}^{{N}_{c} - 1} {f}_{c}^{I} ( n - 1 , p ) {f}_{c}^{I} ( 0 , p ) & ⋯ & {\sum }_{p = 0}^{{N}_{c} - 1} {f}_{c}^{I} ( n - 1 , p ) {f}_{c}^{I} ( n - 1 , p )\end{matrix} ]\end{matrix} \begin{matrix}[ \begin{matrix}{w}_{c} ( 0 ) \\ ⋮ \\ {w}_{c} ( n - 1 )\end{matrix} ] .\end{matrix} \qquad ( 10 )$$

As such, the final LMS optimized coefficients for each class c can be obtained using an inverse matrix as relation (11) below:

$$[ \begin{matrix}{w}_{c} ( 0 ) \\ ⋮ \\ {w}_{c} ( n - 1 )\end{matrix} ] = {\begin{matrix}[ \begin{matrix}{\sum }_{p = 0}^{{N}_{c} - 1} {f}_{c}^{I} ( 0 , p ) {f}_{c}^{I} ( 0 , p ) & ⋯ & {\sum }_{p = 0}^{{N}_{c} - 1} {f}_{c}^{I} ( 0 , p ) {f}_{c}^{I} ( n - 1 , p ) \\ & ⋮ & \\ {\sum }_{p = 0}^{{N}_{c} - 1} {f}_{c}^{I} ( n - 1 , p ) {f}_{c}^{I} ( 0 , p ) & ⋯ & {\sum }_{p = 0}^{{N}_{c} - 1} {f}_{c}^{I} ( n - 1 , p ) {f}_{c}^{I} ( n - 1 , p )\end{matrix} ]\end{matrix}}^{- 1} \begin{matrix}[ \begin{matrix}{\sum }_{p = 0}^{{N}_{c} - 1} {f}_{c}^{I} ( 0 , p ) {f}_{c}^{R} ( p ) \\ ⋮ \\ {\sum }_{p = 0}^{{N}_{c} - 1} {f}_{c}^{I} ( n - 1 , p ) {f}_{c}^{R} ( p )\end{matrix} ]\end{matrix} . \qquad ( 11 )$$

In a detail enhancement image processing approach, the corresponding dictionary w can be obtained with an original (reference) image f^{R} and a blurred (distorted) image f^{I}. Similarly, reference f^{R} and noise corrupted images f^{I} are used to obtain a set of weighting coefficients which is a dictionary for a de-noising process. The above process can be used for other applications under different requirements such as contrast enhancement, super-resolution, and etc.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof, however, other versions are possible. Therefore, the spirit and scope of the appended claims should not be limited to the description of the preferred versions contained herein.

What is claimed is:

1. A method for processing a digitized image including multiple pixels, the method comprising:
determining a characteristic value for a set of image pixels;
determining a classification for the set of pixels based on the characteristic value;
accessing a dictionary including transforms, and retrieving transforms for the set of pixels based on said classification; and
applying the transforms to the set of pixels to obtain output pixels.

2. The method of claim 1, wherein the transforms comprise weighting coefficients.

3. The method of claim 2, wherein:
determining a characteristic value for the set of pixels further includes reordering the set of pixels based on a selected image processing type, and determining a characteristic value for the set of reordered pixels;
accessing a dictionary further includes accessing a dictionary including weighting coefficients for said image processing type, and retrieving weighting coefficients therefrom for the set of pixels based on said classification; and
applying the weighting coefficients to the reordered set of pixels further includes applying the weighting coefficients to the set of pixels according to said selected image processing type to obtain weighted pixel values.

4. The method of claim 3, wherein determining a characteristic value for the set of pixels further includes determining a characteristic value for the neighboring pixels relative to said selected pixel.

5. The method of claim 3, wherein reordering the set of pixels includes reordering the pixels according to their spatial distances and intensity deviations, relative to the selected pixel according to a penalty function.

6. The method of claim 3, wherein applying the weighting coefficients to the set of pixels includes performing one-to-one multiplication on the pixel values with the weighting coefficients.

7. The method of claim 3, wherein applying the weighting coefficients to the reordered set of pixels further includes combining the weighted pixel values as output image pixel values.

8. The method of claim 1, wherein the dictionary includes a set of transforms corresponding to a set of image processing techniques.

9. The method of claim 1 further including initially selecting a set of input pixels including a selected pixel and neighboring pixels, and then determining a characteristic value for the set of pixels.

10. An apparatus for processing a digitized image including multiple pixels, comprising:
a characteristic determination module configured for determining a characteristic value for a set of image pixels;
a classification module configured for determining a classification for the set of pixels based on the characteristic value;
an access module configured for accessing a dictionary including transforms, and retrieving transforms for the set of pixels based on said classification; and
an application module configured for applying the transforms to the set of pixels to obtain output pixels.

11. The apparatus of claim 10, wherein the transforms comprise weighting coefficients.

12. The apparatus of claim 11 further including a reordering module configured for reordering the set of pixels based on a selected image processing type, such that the characteristic determination module is further configured for determining a characteristic value for the set of reordered pixels based on a selected image processing type, and determining a characteristic value for the set of reordered pixels.

13. The apparatus of claim 12, wherein:
the access module is further configured for accessing a dictionary including weighting coefficients for said image processing type, and retrieving weighting coefficients therefrom for the set of pixels based on said classification; and
the application module is further configured for applying the weighting coefficients to the set of pixels according to said selected image processing type to obtain weighted pixel values.

14. The apparatus of claim 13, wherein the characteristic determination module is further configured for determining a characteristic value for the neighboring pixels relative to said selected pixel.

15. The apparatus of claim 13, wherein the reordering module is further configured for reordering the set of pixels according to their spatial distances and intensity deviations, relative to the selected pixel according to a penalty function.

16. The apparatus of claim 13, wherein the application module is further configured for performing one-to-one multiplication on the pixel values with the weighting coefficients.

17. The apparatus of claim 13 further including a combining module configured for combining the weighted pixel values as output image pixel values.

18. The apparatus of claim 10, wherein the dictionary includes a set of transforms corresponding to a set of image processing techniques.

19. The apparatus of claim 10 further including a selector configured for initially selecting a set of input pixels including a selected pixel and neighboring pixels, such that the characteristic determination module is further configured for determining a characteristic value for the set of pixels.

20. A system for processing a digitized image including multiple pixels, comprising:
a characteristic determination module configured for determining a characteristic value for a set of image pixels;
a classification module configured for determining a classification for the set of pixels based on the characteristic value;
a dictionary including image processing transforms;
an access module configured for accessing a dictionary including transforms, and retrieving transforms for the set of pixels based on said classification; and
an application module configured for applying the transforms to the set of pixels to obtain output pixels.

21. The system of claim 20, wherein the transforms comprise weighting coefficients.

22. The system of claim 21 further including a reordering module configured for reordering the set of pixels based on a selected image processing type, such that the characteristic determination module is further configured for determining a characteristic value for the set of reordered pixels based on a selected image processing type, and determining a characteristic value for the set of reordered pixels,
wherein the access module is further configured for accessing a dictionary including weighting coefficients for said image processing type, and retrieving weighting coefficients therefrom for the set of pixels based on said classification; and the application module is further configured for applying the weighting coefficients to the set of pixels according to said selected image processing type to obtain weighted pixel values.

23. The system of claim 22, wherein the reordering module is further configured for reordering the set of pixels according to their spatial distances and intensity deviations, relative to the selected pixel according to a penalty function.

24. The system of claim 23 further including a combining module configured for combining the weighted pixel values as output image pixel values.

25. The system of claim 20, wherein the dictionary further includes a set of transforms corresponding to a set of image processing techniques.
